(19) United States
(12) Patent Application Publication
(10) Pub. No.: US 2010/0321649 A1
(43) Pub. Date: Dec. 23, 2010

(54) Optical element

(75) Inventor: Norman Baer, Aalen (DE)

Correspondence Address: FISH & RICHARDSON P.C. (BO), P.O. BOX 1022, MINNEAPOLIS, MN, 55440-1022, US

(73) Assignee: CARL ZEISS SMT AG, Oberkochen (DE)

(21) Appl. No.: 12/817,915

(22) Filed: Jun. 17, 2010

(30) Foreign Application Priority Data
Jun. 18, 2009 (DE) 10 2009 029 776.6

(51) Int. Cl. G03B 27/52; G03B 27/32

(52) U.S. Cl. 355/30; 355/77

(57) ABSTRACT

An optical element embodied as a front surface mirror or as a lens wherein the optical element has at least one partial region composed of a material which has the property that the material is cooled upon irradiation with suitable excitation light.

### CROSS-REFERENCE TO RELATED APPLICATIONS

This application claims priority under 35 U.S.C. §119 to German Patent Application DE 10 2009 029 776.6, filed Jun. 18, 2009. The contents of this application is hereby incorporated by reference in its entirety.

### FIELD OF THE INVENTION

The disclosure relates to an optical element that can be embodied as a front surface mirror or as a lens, an optical system composed of an optical element of this type, and also a method for cooling an optical element embodied as a front surface mirror or as a lens. Mirrors and lenses are used in beam guiding systems, in particular in objectives, in order to deflect, focus or defocus light. Stringent requirements are commonly made of the quality and optical stability of optical elements primarily in the case of use within a microlithography projection exposure apparatus.

### BACKGROUND

In microlithographic projection exposure apparatuses such as are used in the production of large scale integrated electrical circuits, for instance, the heating of the optical elements by the used light constitutes a generally non-negligible cause of optical disturbances in the apparatuses.

In the case of the materials conventionally used for optical elements, heating leads to a change in volume of the optical elements and hence to a change in shape, which directly alters the optical properties of the optical elements.

Moreover, the change in shape is usually accompanied by mechanical stresses in the material, which can affect the refractive index of said material. At the microscopic level, greater thermal motion leads directly to an alteration of the refractive index. These influences alter the effect of a lens and ultimately become apparent as imaging aberrations during projection. If the imaging aberrations are rotationally symmetrical with respect to the optical axis, compensation is often possible using measures known per se, e.g., a readjustment of individual optical elements.

The situation is more difficult in the case of imaging aberrations which are not rotationally symmetrical, such as are caused, in particular, by the slotted image fields that are now frequently used. In this respect, U.S. Pat. No. 6,781,668 B2, for example, has proposed symmetrizing the temperature distribution in an optical element and then compensating for remaining rotationally symmetrical imaging aberrations in a manner known per se. For this purpose, a cooling gas stream is directed onto the relevant optical element. This is not always possible, however, e.g., for reasons of structural space.

In the case of catadioptric or catoptric projection objectives, the heating of the mirrors can be counteracted by active cooling of the mirror rear side. This is possible for example by cooling with cooling liquids that are passed through cooling channels in the mirror substrate. On account of the flow of the cooling liquid, however, vibrations of the mirror can occur, which disturb the imaging in the case of use in a projection objective.

However, optical elements of an illumination system for a microlithography projection exposure apparatus are also heated by the illumination light, as a result of which the optical properties of the optical elements can be altered.

### SUMMARY

Systems and methods for the active cooling of optical elements, in particular of front surface mirrors or lenses, are disclosed.

Active cooling can be achieved using an optical element embodied as a front surface mirror or as a lens, which optical element has at least one partial region composed of a material which has the property that it is cooled upon irradiation with suitable excitation light. This makes use of the fact that there are materials which convert a virtually monochromatic light beam into shorter-wave fluorescent light using anti-Stokes fluorescence. The energy used for this purpose is drawn from the material, which is thereupon cooled. In the case of anti-Stokes fluorescence, by way of example, electrons that have been excited from their ground state by a thermal phonon are brought to a higher energy by a laser photon, and at said higher energy they are excited again by a phonon. The electrons subsequently fall back to their ground state, and in the process they emit a fluorescent photon having a shorter wavelength in comparison with the laser photon. The cycle “phonon-laser photon-phonon-fluorescent photon” can then begin anew. However, the cycle “phonon-laser photon-fluorescent photon” or the cycle “laser photon-phonon-fluorescent photon” is also possible. This so-called “optical cooling” (“optical refrigeration”) is known for example from the article “Optical Refrigeration” by Mansoor Sheik-Bahae and Richard I. Epstein, published in Nature Photonics, Vol. 1, December 2007.

In this case, the optical element includes this suitable material at least in a partial region. Consequently, the optical element can include this material completely or only in individual regions. In the case of a mirror or a lens, by way of example, one extent of the region can extend along a partial section of the element axis of the mirror or of the lens. The extent of the region which is perpendicular thereto can extend as far as the edge of the optical element. The partial region can seamlessly join the optically used surface or be separated from the latter by a region which cannot be excited to effect anti-Stokes fluorescence.

A suitable excitation light is present when the wavelength of the excitation light is chosen such that the excitation light is absorbed in the material and the material is thereby excited to effect anti-Stokes fluorescence.

The optical element can be embodied as a lens or as a front surface mirror. A front surface mirror is understood to mean a mirror in the case of which the radiation is reflected at the surface of the mirror, or at a suitable reflective coating applied on the mirror surface, rather than—as in the case of a rear surface mirror—first penetrating into the mirror so as then to be reflected at the rear surface of the mirror.

In some embodiments, glasses or crystals doped with rare earths are used as materials which can be excited to effect anti-Stokes fluorescence.

Suitable materials are, for example: ZBLANP:Yb³⁺, ZBLAN:Yb³⁺, CNBZn:Yb³⁺, BIG:Yb³ KGd(WO₄):Yb³⁺, KY(WO₄)₂;Yb³⁺, YAG:Yb³⁺, Y₂SiO₅:Yb³⁺, KPb₂Cl₅:Yb³⁺, BaY₂F₈:Yb³⁺, ZBLANP:Tm³⁺, BaY₂F₈:Tm³⁺, CNBZn:Er³⁺, KPb₂Cl₅:Er³⁺.

In some cases, the heating of an optical element on account of the used light does not take place in a manner distributed homogeneously over the optical element, but rather can be location-dependent. In certain embodiments, therefore, the magnitude of the doping with rare earths within the partial region is dependent on the location. As a result, the cooling of the optical element can be influenced in a targeted manner. The higher the doping at a location, the greater the absorption of the excitation light and hence the cooling. By way of example, the doping with rare earths can be effected between 0 and 3 percent depending on the location.

In some embodiments, the optical element has a reflective coating configured in such a way that the excitation light is reflected at the reflective coating and is still situated in the partial region after reflection. As a result, the excitation light covers a longer distance within the partial region, thereby increasing the chance of a photon of the excitation light being absorbed and the process of anti-Stokes fluorescence being excited.

In certain embodiments, the optical element has a side surface and the latter, at least in part, is reflectively coated for the excitation light. An optical element generally has a front surface, a rear surface and a side surface. In the case of a lens, the used radiation passes firstly through the front surface and then through the rear surface. In the case of a front surface mirror, the used radiation is reflected at the front surface, while the rear surface is arranged opposite the front surface. The side surfaces delimit the optical element toward the side. In the case of rotationally symmetrical optical elements, these are generally the surfaces which are oriented parallel to the axis of rotation of the optical element.

In some embodiments, the side surfaces are configured in such a way that the excitation light is reflected at least twice at the reflective coating. An excitation light beam therefore impinges a first time on the reflective coating, is reflected thereat and impinges at least one further time at a different location on the reflective coating, the excitation light beam being reflected a further time. This ensures that the excitation light beam covers a longest possible distance in the partial region. It is also possible to configure the side surface in such a way that the excitation light beam no longer leaves the partial region at all before being completely absorbed. In this case, the reflective coating acts in a manner similar to a cavity.

In certain embodiments, the partial region with the cooling material is embodied as a cylinder. In this case, the side surface of the cylinder coincides with the side surface of the optical element. The form of the cylinder having the circular cross section has the advantage that an excitation light beam that moves perpendicularly to the cylinder axis is reflected back and forth within the cylinder until it is absorbed. The side surfaces of the cylinder, apart from those regions in which the excitation light enters into the cylinder, are then provided with a reflective coating for the excitation light. In this case, the entrance openings are chosen such that, on the one hand, the excitation light can enter in a manner free of losses and, on the other hand, as little excitation light as possible which is reflected back and forth within the cylinder can leave the cylinder again through the entrance openings.

In some embodiments, the optical element is part of an optical system which furthermore also has at least one device which guides the excitation light into the partial region. The device comprises, for example, a suitable light source for the excitation light, for example a tunable diode-pumped Yb:YAG laser or other laser light sources which make available suitable excitation light for the individual possible materials. Furthermore, the device can comprise a focusing unit, which focuses the excitation light onto the entrance opening in the reflective coating.

In certain embodiments, the device is configured in such a way that the excitation light has a predetermined angular spectrum upon entrance into the optical element. Angular spectrum is understood to mean the distribution of the angles of incidence of the excitation light beams with respect to the surface normal at the entrance location into the optical element. What can be achieved using the angular spectrum of the light bundle, for example, is that the material in the partial region is excited as homogenously as possible and the material is thus cooled correspondingly homogeneously. It is also possible, however, using the angular spectrum, to apply excitation light only to specific regions of the partial region. Thus, within a circular resonator, in particular, it is possible to excite only ring-shaped edge regions with the excitation light reflected back and forth and thus to cool an annular region.

In some embodiments, the device is configured in such a way that the intensity of the excitation light can be adjusted. As a result, it is possible to adapt the cooling to the heating of the optical element.

In certain embodiments, for example, where the side surfaces of the optical element have the reflective coating for the excitation light, the device is configured in such a way that the excitation light is guided from the side surfaces into the partial region.

In some embodiments, the optical system has a plurality of devices by which the excitation light is guided into the partial region. As a result, it is possible to improve the homogeneity during the excitation of the material and thus to cool the material even more homogeneously than is possible in the case of only one device.

In certain embodiments, the optical system has an even number of devices by which the excitation light is guided into the partial region.

If the optical system has a plurality of devices, embodiments can provide for the devices to be configured in such a way that the angular spectrum of the excitation light and/or the intensity of the excitation light upon entrance into the material differ from one another in the case of at least two devices. As a result, it is possible to adjust the location-dependent intensity distribution within the partial region.

In some embodiments, the optical systems are used in a microlithography projection exposure apparatus.

The object of the disclosure is also achieved using a method for cooling an optical element embodied as a front surface mirror or a lens, wherein the optical element is cooled by irradiation with suitable excitation light. While it is usually assumed that light leads to the heating of optical elements, by using anti-Stokes fluorescence the irradiation of an optical element with suitable excitation light can also lead to the cooling of the optical element.

### BRIEF DESCRIPTION OF THE DRAWINGS

Details of the disclosure are explained more thoroughly below on the basis of the exemplary embodiments illustrated in the figures, in which specifically:

FIG. 1 shows a schematic illustration of an optical system with an optical element embodied as a lens, in side view;

FIG. 2 shows a schematic illustration of the optical system from FIG. 1, in plan view;

FIG. 3 shows a schematic illustration of an optical system with an optical element embodied as a front surface mirror, in side view;

FIG. 4 shows a schematic illustration of the optical system from FIG. 3, in plan view;

FIG. 5 shows a schematic illustration of a further exemplary embodiment of an optical system with an optical element embodied as a mirror, in side view;

FIG. 6 shows a schematic illustration of a microlithography projection exposure apparatus containing optical systems.

### DETAILED DESCRIPTION

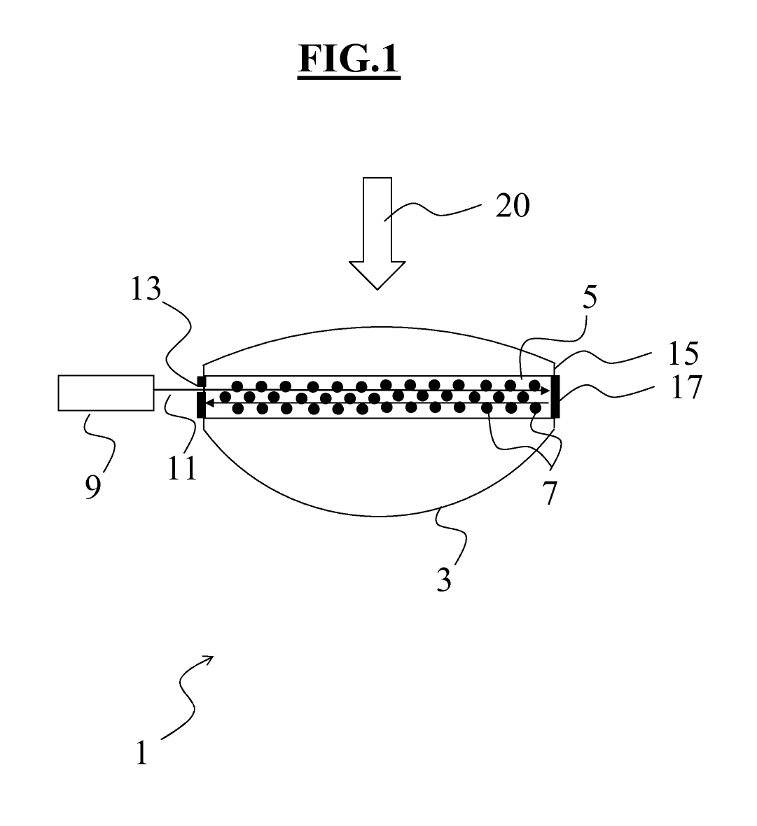

FIG. 1 shows, in schematic illustration as a side view, an optical system 1 comprising an optical element 3 embodied as a lens. The lens 3 includes a transparent material suitable for the respective used light 25. The lens 3 is illustrated as a biconvex lens having a positive refractive power in FIG. 1. However, a biconcave lens having a negative refractive power or a meniscus lens having a positive or negative refractive power can also be involved. The diameter of the lens is adapted to the respective application. In a projection objective for a microlithography projection exposure apparatus, the diameter is typically between 100 mm and 300 mm. The lens 3 has the partial region 5, which consists of a material which exhibits anti-Stokes fluorescence upon excitation with suitable excitation light 11. In FIG. 1, this is ZBLAN, that is to say a glass having the composition 53% ZrF₄-20% BaF₂-4% LaF₃-3% AlF₃-20% NaF(mol. %), which was doped with Yb³⁺. The magnitude of the doping is 2% and is effected homogeneously over the partial region, as is indicated schematically by the uniform distribution of the doping atoms 7.

The optical system 1 includes the device 9, which makes the excitation light 11 available. The device 9 includes the tunable diode-pumped Yb:YAG laser, which generates laser light having a wavelength of between 1020 and 1035 nm.

The side surface 15 of the lens 3 is embodied in cylindrical fashion, the cylinder axis coinciding with the axis of symmetry of the lens 3. The partial region 5 has the form of a cylinder, the side surface of which lies on the side surface of the lens 3. The cylindrical partial region 5 lies completely within the lens 3, such that regions of the lens 3 outside the partial region 5 are not composed of the material ZBLAN:Yb³⁺ and therefore do not exhibit anti-Stokes fluorescence upon irradiation with the excitation light 11.

The partial region 5 is embodied with the reflective coating 17 at the side surface. The reflective coating is optimized for the wavelength of the excitation light. The reflective coating can consist of gold or a suitable dielectric multilayer coating, whereby a reflectivity for the excitation light of more than 99.5% is obtained. The reflective coating 17 has an entrance opening 13, through which the excitation light 11 can enter into the partial region 5.

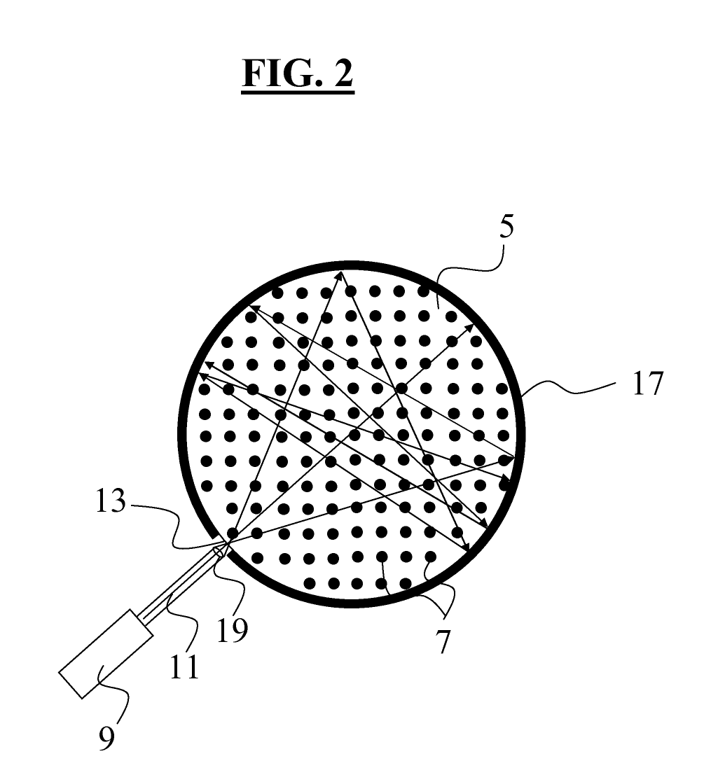

FIG. 2 shows the optical system from FIG. 1 in plan view. It becomes clear here that the device 9 has a focusing unit 19, which focuses the excitation light 11 onto the entrance opening 13, as a result of which a predetermined angular spectrum of the excitation light is produced at the entrance into the cylindrical partial region 5. A continuous angular spectrum between the angle of incidence of 0° upon incidence along the surface normal to the side surface at the entrance opening 13 and a maximum angle of incidence is produced in this case. The excitation light beams 11 are multiply reflected back and forth at the reflective coating 17 until they are absorbed by one of the doping atoms 7. The optical system 1 has only one device 9 for coupling in the excitation light 11. In order to improve the homogeneous excitation of the partial region 5, further devices 9 can be provided along the circumference of the lens 3, which guide the excitation light 11 into the partial region 5 via a corresponding number of entrance openings 13.

The optical element 3 is heated by absorption of the incident used light 20. For cooling purposes the optical element 3 is irradiated with excitation light 11. The excitation light 11 excites the doping atoms 7 to effect anti-Stokes fluorescence, shorter-wave fluorescent light being generated in the process. The energy gain between the absorbed excitation photon and the reemitted fluorescent photon leads to the cooling of the optical element. In this case, the fluorescent radiation is emitted in all directions. In order that the fluorescent radiation does not lead once again to the heating of the optical element 3 or of other optical elements upstream or downstream in the used beam path, the fluorescent radiation should be eliminated to the greatest possible extent using suitable measures such as e.g. absorption traps outside the used beam path.

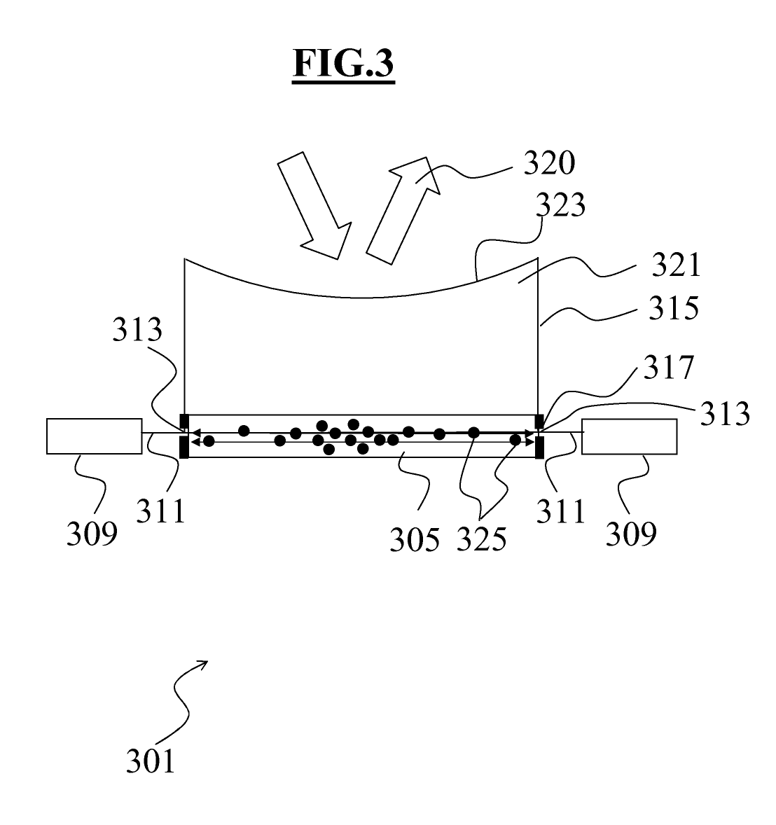

FIG. 3 shows, in schematic illustration as a side view, an optical system 301 comprising an optical element 321 embodied as a front surface mirror. The elements in FIG. 3 which correspond to the elements from FIG. 1 have the same reference signs as in FIG. 1 increased by the number 300. For a description of these elements, reference is made to the description concerning FIG. 1.

The mirror 321 is provided for an EUV microlithography projection exposure apparatus and therefore has, at its front surface 323, a suitable multilayer coating optimized for a used wavelength in the range of 5 to 15 nm. In this case, the EUV used light 320 is reflected at the front surface 323. The mirror 321 is embodied as a concave mirror having a positive refractive power. However, it can also be embodied as a convex mirror having a negative refractive power or as a plane mirror without refractive power. The substrate material of the mirror is adapted for use in EUV. The partial region 305 once again consists of ZBLAN and is doped with Yb³⁺. However, the magnitude of the doping 325 is not homogeneous within the partial region, but rather has a location-dependent distribution, as is indicated by the density of the doping atoms 325 which increases toward the center. Thus, the doping 325 is 3% in the center of the partial region 305 and only 1% at the edge of the mirror. Thus, upon homogeneous excitation with excitation light 311, the cooling effect is significantly higher in the center of the mirror 321 than at the edge of the mirror 321.

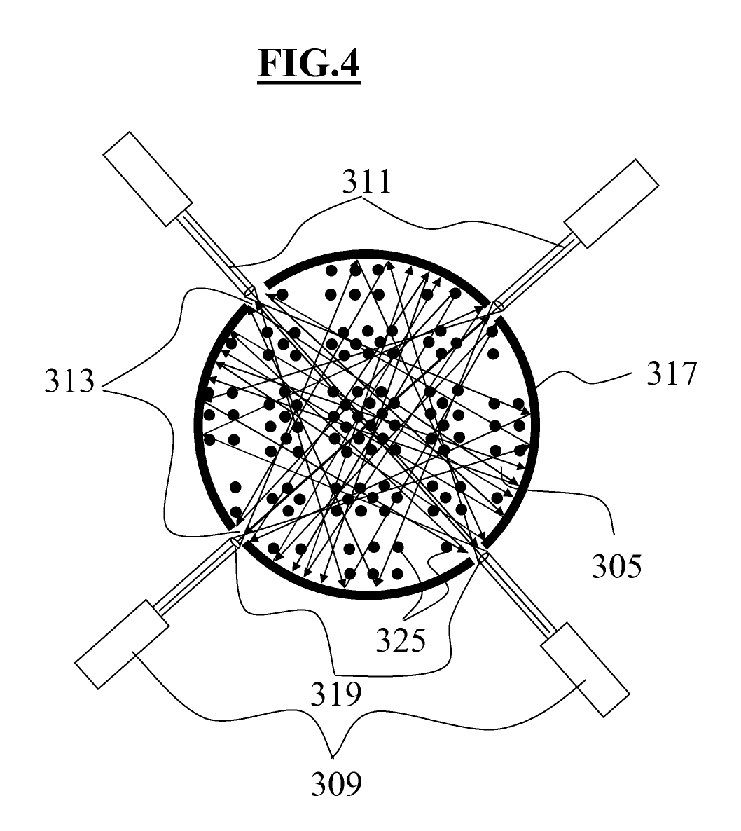

FIG. 4 shows the optical system 301 in plan view. In this case, the radially increasing doping is indicated by the radially increasing density of the doping atoms 325. This distribution of the doping 325 is advantageous when the mirror 321 is heated by the EUV used light to a greater extent particularly in the center, that is to say around the element axis of the mirror 321, than in the edge regions. Since approximately 30% of the EUV used light is absorbed in the multilayer coating 323 and at the same time the mirror is situated in high vacuum, the cooling of EUV mirrors is particularly critical. Besides the variation of the doping 325 of the partial region 305 with rare earths, which can no longer be altered after the production of the optical element 321, it is also possible to adjust the cooling effect by virtue of the laser light source for the excitation light 311 having a variable power, whereby the integral cooling effect can be correspondingly adjusted.

The optical system 301 has four devices 309 by which the excitation 311 is guided into the partial region 305. Substantially homogeneous excitation and hence cooling of the material are possible as a result. In order to improve the homogeneity, however, it is also possible to arrange further devices along the circumference.

The devices 309 are embodied in such a way that the angular spectrum and also the intensity of the excitation light 311 are adjustable at each entrance opening 313. Given a corresponding number of devices 309 it is thus possible to produce virtually any location-dependent intensity distributions of the excitation light within the partial region 305.

The optical element 321 is heated by absorption of the incident used light 320 in the multilayer coating applied on the front surface 323. For cooling purposes, the optical element 321 is irradiated with excitation light 311. The excitation light 311 excites the doping atoms 325 to effect anti-Stokes fluorescence, shorter-wave fluorescent light being generated in the process. The energy gain between the absorbed excitation photon and the reemitted fluorescent photon leads to the cooling of the optical element. In this case, the fluorescent radiation is emitted in all directions. In order that the fluorescent radiation does not lead once again to the heating of the optical element 321 or other optical elements of the optical system 301, the fluorescent radiation should be eliminated to the greatest possible extent using suitable measures such as, e.g., absorption traps. In the case of catoptric or catadioptric optical systems that use cooled front surface mirrors, this is simpler than in the case of lenses as optically cooled optical elements, since the fluorescent radiation is separated from the used beam path. In order that the fluorescent radiation is led out from the mirror 321 more effectively, a further reflective coating for the fluorescent light can be provided between the partial region 305 and the front surface 323 of the mirror 321.

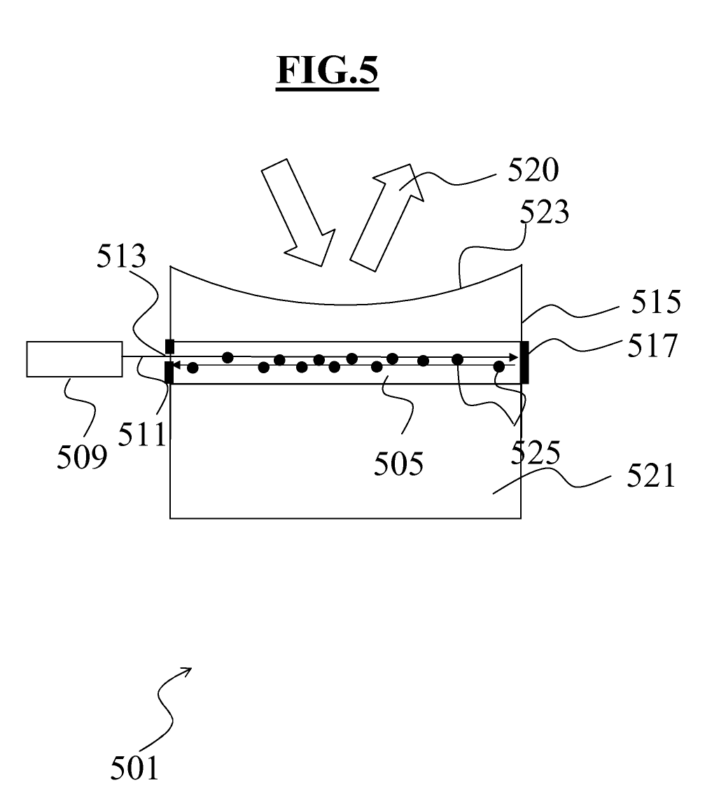

FIG. 5 shows, in schematic illustration as a side view, a further exemplary embodiment of an optical system 501 comprising an optical element 521 embodied as a mirror. The elements in FIG. 5 which correspond to the elements from FIG. 1 and FIG. 3 have the same reference signs as in FIG. 1 and in FIG. 3 increased by the number 500 and 200 respectively. For a description of these elements, reference is made to the description concerning FIG. 1 and FIG. 3.

The exemplary embodiment in FIG. 5 differs from the exemplary embodiment in FIG. 3 in that the partial region 505 with the material which is excited by suitable excitation light to effect anti-Stokes fluorescence is arranged closer to the mirror surface 523. Regions which do not consist of the material which can be excited to effect anti-Stokes fluorescence are therefore situated above and below the cylindrical partial region 505. These regions consist of suitable mirror substrate material. What is achieved using this measure is that the cooling by the material in the partial region 505 takes place closer to the mirror surface 523 and more effective cooling is thus ensured. This is of importance particularly when the cooling within the partial region 505 does not take place homogeneously, but rather has a location-dependent distribution that is intended correspondingly to be transferred to the front surface 323 in a location-dependent manner. In this case, location-dependent cooling can be achieved, firstly, by the doping 525 being configured in a location-dependent manner. Secondly, however, location-dependent cooling can also be achieved by the excitation light 511 in the entrance opening 513 having an angular spectrum such that, rather than the entire partial region 505, only parts thereof are illuminated with the excitation light. Using the device 509 it is possible to adjust the angular spectrum for example in such a way that only an annular ring in the outer region of the partial region 505 is illuminated with excitation light. This may be of interest, for example, when the mirror 521 is situated in the region of a pupil plane and the pupil plane is illuminated annularly, as is used in lithographic imaging in order to increase the resolution limit. If the mirror 521 is illuminated annularly, however, then this also results in annular heating of the mirror 521. This annularly heated region can then be effectively cooled by the adaptation of the angle distribution of the excitation light 511. Only one device 509 is illustrated. In order to produce any desired location-dependent intensity distributions of the excitation light, further devices 509 are arranged along the side surface 515 of the mirror 521, which guide the excitation light 511 into the partial region 505 via a corresponding number of entrance openings 513.

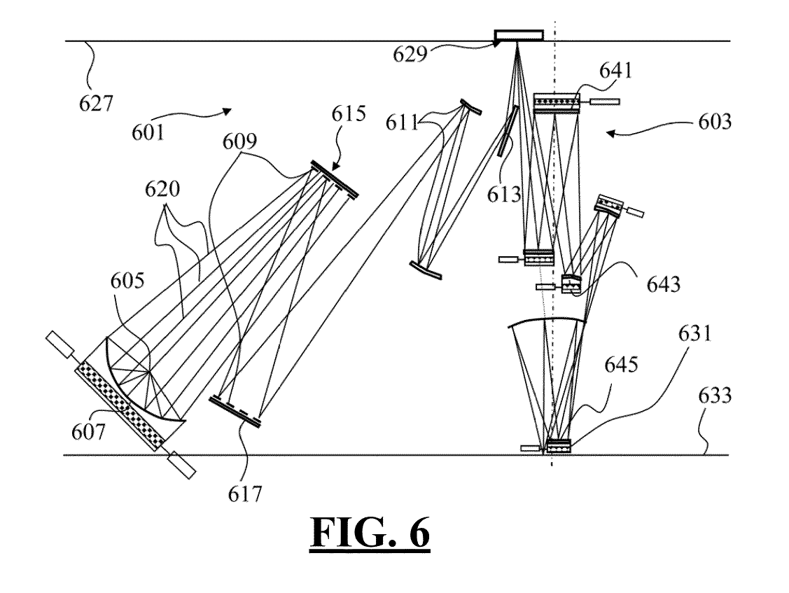

FIG. 6 shows optical components of a microlithography projection exposure apparatus. The apparatus comprises an illumination system 601 and a projection objective 603 and is operated with the radiation from a light source 605. The light source 605 can be, inter alia, a laser plasma source or a discharge source. Such light sources generate a radiation 620 in the EUV range, that is to say having wavelengths of between 5 nm and 15 nm. In this wavelength range, an illumination system and a projection objective comprise principally reflective components. The radiation 620 emerging from the light source 605 is collected using a collector 607 and directed into the illumination system 601. The illumination system 601 here comprises a mixing unit 609 consisting of two faceted mirrors 615 and 617, a telescope optical unit 611 and a field shaping mirror 613. The projection objective 603 serves for imaging an object field 629 in the object plane 627 onto an image field 631 in the image plane 633 and consists here of 6 mirrors.

Individual mirrors of the microlithography projection exposure apparatus are embodied as optically cooled optical elements.

Thus, in the illumination system 601, the normal-incidence collector mirror 607 is affected by a particularly large thermal load. Said collector mirror 607 can be cooled by virtue of the fact that it has a partial region composed of a material which exhibits anti-Stokes fluorescence upon excitation with suitable excitation light. In order to be able to direct a sufficient amount of excitation light into the partial region and, in addition, to obtain substantially homogeneous excitation, the reflective coating of the partial region has, at a plurality of locations, entrance openings through which the excitation light can be guided into the partial region.

Further components are, in particular, the mirrors of the projection objective 603, which, on account of the heating by the EUV used light, change their shape indeed only to a small extent, yet the imaging of the object into the image plane 633 is appreciably disturbed as a result. Therefore, all the mirrors of the projection objective 603 are provided with at least one device for optical cooling. The heating of the mirrors of the projection objective 603 is dependent, firstly, on their order in the beam path. This is because the integral power of the used light decreases from mirror to mirror on account of the absorption in the multilayer coatings. Secondly, however, the heating is also dependent on the diameter of the mirror. If a small mirror is involved, then the integral light power impinges on a smaller area than in the case of a large mirror, with the result that smaller mirrors are heated to a greater extent. This is the case particularly for the third mirror 643 and fifth mirror 645 in the light direction. The cooling and hence the excitation of the partial regions with excitation light should therefore be adapted correspondingly to the heating of the mirrors. This can be effected, for example, by adapting the magnitude of the doping of the material in the partial region. In another instance, however, it is also possible to adapt the power of the excitation laser for generating the excitation light.

Furthermore, the mirrors are not heated homogeneously over the mirror surface. Thus, in particular the second mirror 641 of the projection objective 603 in the light direction, said second mirror being arranged in the pupil plane, will generally have inhomogeneous illumination depending on the so-called illumination setting. The illumination setting defines the angular spectrum with which an object to be imaged within the object field 629 is illuminated by the illumination system 601. Said setting can be, by way of example, a circular, annular, dipole or quadrupole illumination setting. In the case of an annular illumination setting, the illumination of a pupil plane is ring-shaped. The mirror 641 arranged in the pupil plane is thus heated by absorption in the multilayer coating in a ring-shaped region. This annular heating of the mirror 641 can be counteracted by annular cooling, which is produced by virtue of the fact that the excitation light at the entrance into the partial region within the mirror to be cooled has an angular spectrum which leads to annular illumination within the partial region. As an alternative, the magnitude of the doping of the partial region can also be effected in a location-dependent manner. However, this would produce ideal cooling only for this form of the local heating of the mirror 641. Since different illumination settings are used in microlithography projection exposure apparatuses, however, it is more favorable firstly to choose a location-dependent doping distribution that satisfies as many heating profiles as possible, so as then, in the case of heating of the mirror 641 that is dependent on the operating mode, to obtain the location-dependent cooling using corresponding adaptation of the angular spectrum of the excitation light.

Other embodiments are in the following claims.

1. An optical element, comprising:
at least one partial region composed of a material which has the property that the material is cooled upon irradiation with suitable excitation light,
wherein the optical element is an optical element of an objective and a front surface mirror or a lens.

2. An optical element, comprising:
at least one partial region composed of a material which has the property that the material is cooled upon irradiation with suitable excitation light,
wherein the optical element is a front surface mirror or a lens of a beam guiding system of a microlithography projection exposure apparatus.

3. The optical element of claim 1, wherein the material is a glass doped with rare earths or a crystal doped with rare earths.

4. The optical element of claim 1, wherein the material is selected from the group consisting of ZBLANP:Yb³⁺, ZBLAN:Yb³ CNBZn:Yb³⁺, BIG:Yb³⁺, KGd(WO₄):Yb³⁺, KY(WO₄)₂;Yb³⁺, YAG:Yb³⁺, Y₂SiO₅:Yb³⁺, KPb₂Cl₅:Yb³⁺, BaY₂F₈:Yb³⁺, ZBLANP:Tm³⁺, BaY₂F₈:Tm³⁺, CNBZn:Er³⁺, KPb₂Cl₅:Er³⁺.

5. The optical element of claim 3, wherein the magnitude of the doping with rare earths is location-dependent.

6. The optical element of claim 1, wherein the optical element has a reflective coating for the excitation light, said reflective coating being configured in such a way that the excitation light is reflected back at the reflective coating into the partial region.

7. The optical element of claim 6, wherein the optical element has a side surface and the side surface has at least in part the reflective coating for the excitation light.

8. The optical element of claim 7, wherein the side surface is configured in such a way that the excitation light is reflected at least twice at the reflective coating.

9. The optical element as claimed in claim 7, wherein the partial region has the form of a cylinder, the side surface of which coincides with the side surface of the optical element.

10. The optical element of claim 9, wherein the side surface of the cylinder apart from an entrance location of the excitation light has the reflective coating.

11. An optical system, comprising:
the optical element of claim 1,
wherein the optical system has at least one device which guides the excitation light into the partial region.

12. The optical system of claim 11, wherein the at least one device is configured in such a way that the excitation light has a predetermined angular spectrum upon entrance into the optical element.

13. The optical system of claim 11, wherein the at least one device is configured in such a way that the intensity of the excitation light is adjustable.

14. The optical system of claim 11, wherein the optical element has a side surface, and wherein the at least one device is configured in such a way that the excitation light is guided from the side surface into the partial region.

15. The optical system of claim 11, wherein the optical system has at least one second device alongside a first device, and
wherein the first device and the second device are configured in such a way that the excitation light has in each case a different angular spectrum and/or in each case a different intensity upon entrance into the optical element.

16. A microlithography projection exposure apparatus comprising the optical system of claim 11.

17. A method for cooling an optical element, comprising:
irradiating the optical element with irradiation having a suitable excitation light,
wherein the optical element is a front surface mirror or a lens.
